(19) United States
(12) Patent Application Publication
(10) Pub. No.: US 2021/0016388 A1
(43) Pub. Date: Jan. 21, 2021

(54) METHOD FOR MANUFACTURING COMPOSITE SLAB

(71) Applicant: NIPPON LIGHT METAL COMPANY, LTD., Tokyo (JP)

(72) Inventors: Hisashi HORI, Shizuoka (JP); Hayato SATO, Aichi (JP); Tomohiro KOMOTO, Tokyo (JP)

(73) Assignee: NIPPON LIGHT METAL COMPANY, LTD., Tokyo (JP)

(21) Appl. No.: 17/044,274

(22) PCT Filed: Mar. 18, 2019
(86) PCT No.: PCT/JP2019/011075

§ 371 Date: Sep. 30, 2020

(30) Foreign Application Priority Data
Jun. 14, 2018 (JP) 2018-113979
Jun. 14, 2018 (JP) 2018-113980

(51) Int. Cl. B23K 20/12

(52) U.S. Cl. CPC B23K 20/1265

(57) ABSTRACT

A method for manufacturing a composite slab to manufacture a plural layer clad material composed of different kinds of metals, the method including: a preparation process to prepare a bottom portion, a metallic box body having a peripheral wall portion standing on a peripheral edge of the bottom portion, and a metallic sealing body to seal an opening of the box body; a butting process to butt a side face of the sealing body against an inner wall face of the peripheral wall portion to form a butted portion with intermediate members being inserted in a recessed portion of the box body and a closing process to join and close the butted portion. At least one of the intermediate members is made of a material different from at least one of the box body and the sealing body.

### TECHNICAL FIELD

The present invention relates to a method for manufacturing a composite slab.

### BACKGROUND ART

There is known a method for manufacturing a composite slab composed of different kinds of metals. By forming the composite slab by means of rolling or forging to make thin, a clad material, which is composed of different kinds of metals and has plural layers, can be manufactured. In a patent literature 1, a vacuum hot rolling method in which a composite slab is formed in non-oxidative atmosphere of the vacuum state is described. According to the method, since the composite slab is formed in the non-oxidative atmosphere, the composite slab can be processed without oxide film.

Furthermore, there is known an explosion pressure bonding method in which a composite slab is formed by a method of letting a metal plate collide against a base member at high speed to join them. And further, a composite slab can be formed also by a method of brazing metal plates of different kinds of metals to join them.

### CITATION LIST

### Patent Literature

Patent Literature 1: Japanese Unexamined Patent Publication No. S57-134287

### SUMMARY OF THE INVENTION

### Technical Problem

However, in the foresaid vacuum hot rolling process, rolling rollers need to be arranged in a vacuum chamber, so that it might cause upsizing of the device. And the explosion pressure bonding method has a limit for upsizing in the method. Furthermore, in the brazing, a reaction layer (Cu—Al compound) is made, so that there is a problem that thermal conductivity of the clad material having plural layers is low. And further, a portion joined by the brazing is brittle, so that there is a problem that plastic working cannot be done.

From such a view point, an object of this invention is to provide a method for manufacturing a composite slab, the method being capable of easily manufacturing the composite slab.

### Solution to Problem

In order to solve the problem, the present invention is characterized by a method for manufacturing a composite slab to manufacture a plural layer clad material composed of different kinds of metals, the method comprising: a preparation process to prepare a metallic box body having a bottom portion and a peripheral wall portion standing on a peripheral edge of the bottom portion, and a metallic sealing body to seal an opening of the box body; abutting process to butt a side face of the sealing body against an inner wall face of the peripheral wall portion to form a butted portion with one or plural intermediate members being inserted in a recessed portion of the box body; and a closing process to join and close the butted portion, wherein at least one of the one or plural intermediate members is made of a material different from at least one of the box body and the sealing body.

And, the present invention is characterized by a method for manufacturing a composite slab to manufacture a plural layer clad material composed of different kinds of metals, the method comprising: a preparation process to prepare a metallic box body having a bottom portion and a peripheral wall portion standing on a peripheral edge of the bottom portion, and a metallic sealing body to seal an opening of the box body, and to form a peripheral wall step portion having a step bottom face and a step side face standing on the step bottom face at an inner peripheral edge of the peripheral wall portion; a butting process to place the sealing body on the peripheral wall step portion to butt a side face of the sealing body against the step side face to form a butted portion with one or plural intermediate members being inserted in a recessed portion of the box body; and a closing process to join and close the butted portion, wherein at least one of the one or plural intermediate members is made of a material different from at least one of the box body and the sealing body.

Furthermore, the present invention is characterized by a method for manufacturing a composite slab to manufacture a plural layer clad material composed of different kinds of metals, the method comprising: a preparation process to prepare a metallic box body having a bottom portion and a peripheral wall portion standing on a peripheral edge of the bottom portion, and a metallic sealing body to seal an opening of the box body; a butting process to butt a back face of the sealing body against a peripheral wall end face of the peripheral wall portion to form a butted portion with one or plural intermediate members being inserted in a recessed portion of the box body; and a closing process to join and close the butted portion, wherein at least one of the one or plural intermediate members is made of a material different from at least one of the box body and the sealing body.

According to the method for manufacturing a composite slab, the closing work can be easily performed since the intermediate members are sealed inside the box body and the sealing body.

Furthermore, it is preferable that the method for manufacturing a composite slab further comprises: an evacuation process to evacuate through an exhaust channel provided at the box body or the sealing body to communicate the recessed portion with the outside; and a blocking process to block the communication through the exhaust channel after performing the closing process and the evacuation process.

According to the method, the plural layer clad material is prevented from generating an oxide film inside thereof when the plural layer clad material is manufactured through a rolling or forging process since the inside of the composite slab is evacuated.

Further, it is preferable that in the preparation process of the method for manufacturing a composite slab, the exhaust channel is provided at the peripheral wall portion of the box body, in the closing process of the same, the butted portion is closed by friction stirring with use of a rotary tool, and in the blocking process of the same, the exhaust channel is crossed to be blocked by friction stir welding with use of the rotary tool.

According to the method, the butted portion can be easily joined by friction stirring, and the exhaust channel can be also easily blocked.

And furthermore, the present invention is characterized by a method for manufacturing a composite slab to manufacture a plural layer clad material composed of different kinds of metals, the method comprising: a preparation process to prepare a metallic frame member, a metallic bottom member to cover one opening of the frame member, and a metallic sealing body to cover the other opening of the frame member; a butting process to butt the frame member, the bottom member, and the sealing body against each other to form each butted portion with one or plural intermediate members being inserted in an inside of the frame member; and a closing process to join to close the each butted portion, wherein at least one of the one or plural intermediate members is made of a material different from at least one of the bottom member and the sealing body.

According to the method for manufacturing a composite slab, the closing work can be easily performed since one or plural intermediate members are sealed inside the frame member.

It is preferable that the method for manufacturing a composite slab further comprises: an evacuation process to evacuate through an exhaust channel provided at the frame member, the bottom member or the sealing body to communicate the inside with the outside; and a blocking process to block the communication through the exhaust channel after performing the closing process and the evacuation process.

According to the method, the plural layer clad material is prevented from generating an oxide film inside thereof when the plural layer clad material is manufactured through a rolling or forging process since the inside of the composite slab is evacuated.

It is preferable that in the preparation process of the method for manufacturing a composite slab, the exhaust channel is provided at the frame member, in the closing process of the same, the each butted portion is closed by friction stir welding with use of a rotary tool, and in the blocking process of the same, the exhaust channel is crossed to be blocked by friction stirring with use of the rotary tool.

According to the method, the butted portion can be easily joined by friction stirring, and the exhaust channel can be also easily blocked.

Furthermore, the present invention is characterized by a method for manufacturing a composite slab to manufacture a plural layer clad material composed of different kinds of metals, the method comprising: a butting process to enclose around one intermediate member with plural closing members and butt each member against each other to form a butted portion; an evacuation process to evacuate through an exhaust channel to communicate an inside of the closing members with the outside; a closing process to join and close the butted portion; and a blocking process to block the communication through the exhaust channel after performing the closing process and the evacuation process, wherein the intermediate member is made of copper or a copper alloy, and the closing members are made of aluminum or an aluminum alloy.

Further, the present invention is characterized by a method for manufacturing a composite slab to manufacture a plural layer clad material composed of different kinds of metals, the method comprising: a butting process to enclose around two intermediate members with plural closing members and butt the closing members against each other to form butted portions; an evacuation process to evacuate through an exhaust channel to communicate an inside of the closing members with the outside; a closing process to join and close the butted portion; and a blocking process to block the communication through the exhaust channel after performing the closing process and the evacuation process, wherein the two intermediate members are made of copper or a copper alloy, and the closing members are made of aluminum or an aluminum alloy.

According to the method for manufacturing a composite slab, a composite slab having a high thermal conductivity can be manufactured since oxidizing compound is prevented from being generated by the evacuation process. Further, the joining work can be easily performed by enclosing around the intermediate member(s) with the closing members.

Furthermore, the present invention is characterized by a method for manufacturing a composite slab to manufacture a plural layer clad material composed of different kinds of metals, the method comprising: a butting process to enclose around three or more intermediate members with plural closing members and butt the closing members against each other to form butted portions; an evacuation process to evacuate through an exhaust channel to communicate an inside of the closing members with the outside; a closing process to join and close the butted portion; and a blocking process to block the communication through the exhaust channel after performing the closing process and the evacuation process, wherein two or more of the intermediate members are made of copper or a copper alloy, and one or more of the intermediate members are made of aluminum or an aluminum alloy, and wherein the closing members are made of aluminum or an aluminum alloy.

According to the method for manufacturing a composite slab, a composite slab having a high thermal conductivity can be easily manufactured, since oxidizing compound is prevented from being generated by the evacuation process. Further, the joining work can be easily performed by enclosing around the intermediate members with the closing members.

It is preferable that in the butting process, remover or a removing member is interposed between the two intermediate members to peel off the two intermediate members from each other.

It is preferable that the removing member is made of an aluminum alloy containing 2 mass % or more of Mg.

Furthermore, the removing member is made of aluminum or an aluminum alloy, and at least one of a front face and a back face of the removing member is anodized.

According to the method, plural layer clad material can be easily manufactured since adjacent members can be easily peeled off from each other by remover or a removing member.

### Advantageous Effects of Invention

According to the method for manufacturing a composite slab according to the present invention, the composite slab can be easily manufactured.

### BRIEF DESCRIPTION OF THE DRAWINGS

FIG. 1 is an exploded perspective view showing a preparation process of a method for manufacturing a composite slab according to a first embodiment of the present invention;

FIG. 2 is a cross sectional view showing a butting process of the method for manufacturing the composite slab according to the first embodiment;

FIG. 3 is a plan view showing a closing process of the method for manufacturing the composite slab according to the first embodiment;

FIG. 4 is a cross sectional view showing the closing process of the method for manufacturing the composite slab according to the first embodiment;

FIG. 5 is a plan view showing the closing process of the method for manufacturing the composite slab according to the first embodiment;

FIG. 6 is a plan view showing a blocking process of the method for manufacturing the composite slab according to the first embodiment;

FIG. 7 is a cross sectional view showing the blocking process of the method for manufacturing the composite slab according to the first embodiment;

FIG. 8 is a cross sectional view showing a clad material having plural layers (hereinafter, called as plural layer clad material) obtained by hot rolling process;

FIG. 9 is a cross sectional view showing a butting process of a method for manufacturing a composite slab according to a second embodiment of the present invention;

FIG. 10 is a cross sectional view showing a closing process of the method for manufacturing the composite slab according to the second embodiment;

FIG. 11 is a cross sectional view showing a butting process of a method for manufacturing a composite slab according to a third embodiment of the present invention;

FIG. 12 is a cross sectional view showing a closing process of the method for manufacturing the composite slab according to a third embodiment;

FIG. 13 is an exploded perspective view showing a preparation process of a method for manufacturing a composite slab according to a fourth embodiment of the present invention;

FIG. 14 is a cross sectional view showing a butting process of the method for manufacturing the composite slab according to the fourth embodiment;

FIG. 15 is a cross sectional view showing a closing process of the method for manufacturing the composite slab according to the fourth embodiment;

FIG. 16 is a cross sectional view showing a butting process of a method for manufacturing a composite slab according to a fifth embodiment of the present invention;

FIG. 17 is a cross sectional view showing a closing process of the method for manufacturing the composite slab according to the fifth embodiment;

FIG. 18 is a cross sectional view showing a butting process of a method for manufacturing a composite slab according to a sixth embodiment of the present invention;

FIG. 19 is a cross sectional view showing a closing process of the method for manufacturing the composite slab according to the sixth embodiment;

FIG. 20 is a schematic cross sectional view showing a test body of an example;

FIG. 21 is a table showing conditions and states after rolling on test bodies T1 to T4;

FIG. 22 is a cross sectional view showing the test body T5;

FIG. 23 is a cross sectional view showing the test body T6;

FIG. 24 is a table showing conditions and states after rolling on the test bodies T5 and T6;

FIG. 25A is a cross sectional view showing a plural layer clad material obtained from the test body T5;

FIG. 25B is a cross sectional view showing a plural layer clad material obtained from the test body T6; and

FIG. 26 is a graph showing specific weight vs. thermal conductivity of the plural layer clad materials manufactured from the test bodies T5 and T6.

### DESCRIPTION OF EMBODIMENTS

### First Embodiment

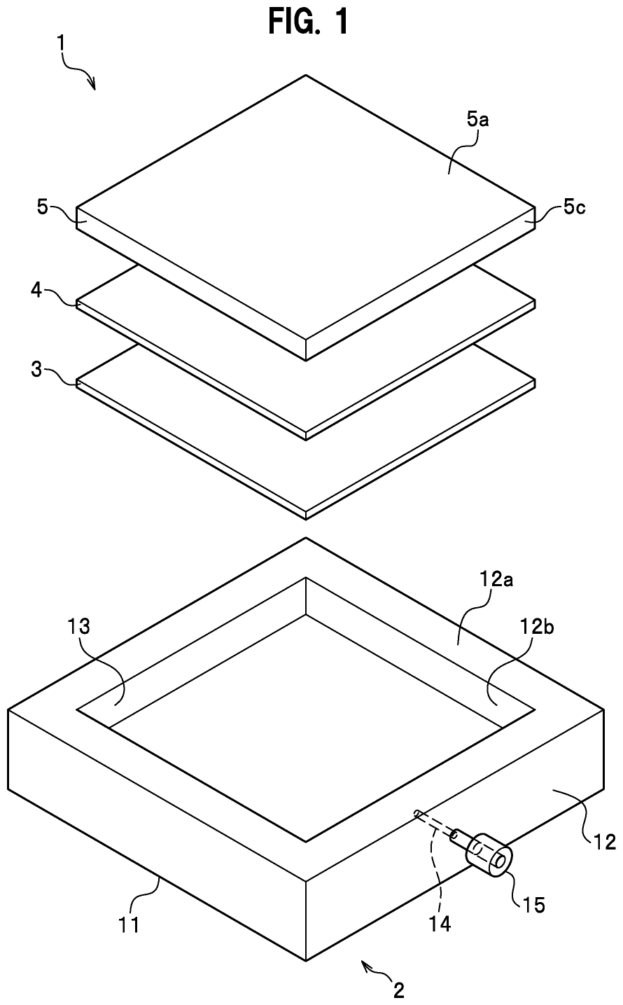

A method for manufacturing a composite slab according to an embodiment of the present invention will be explained in detail with reference to Figures. As shown in FIG. 1, a composite slab 1 is mainly composed of a box body 2, intermediate members 3, 4, and a sealing body 5. The composite slab 1 is a member to manufacture a plural layer clad material by performing a rolling process or a forging process to the composite slab 1 to make it thin. That is, the composite slab 1 is a member, for example, to be inserted between rolling rollers when a hot rolling process is performed. The composite slab 1 accommodates intermediate members 3, 4 therein and is integrated (closed) by joining the box body 2 and the sealing body 5. Note that, hereinafter, an opposite face of a “back face” is described as a “front face”.

The box body 2 is a member to be a base of the composite slab 1 and has a box type shape. The box body 2 is composed of a bottom portion 11 and a peripheral wall portion 12. The bottom portion 11 has a rectangular plate shape. The peripheral wall portion 12 is a portion standing on the peripheral edge of the bottom portion 11 and has a rectangular frame shape. A recessed portion 13 is defined by the bottom portion 11 and the peripheral wall portion 12. An exhaust channel 14, which passes through in a thickness direction, is formed in the peripheral wall portion 12. The exhaust channel 14 is a channel in which air flows when an evacuation process to be described later is performed. The exhaust channel 14 is connected with an evacuation jig 15 at an outer end of the exhaust channel 14. The evacuation jig 15 is connected to an evacuation device when an evacuation process to be described later is performed. Material of the box body 2 is not specifically limited, and in this embodiment, it is aluminum or an aluminum alloy.

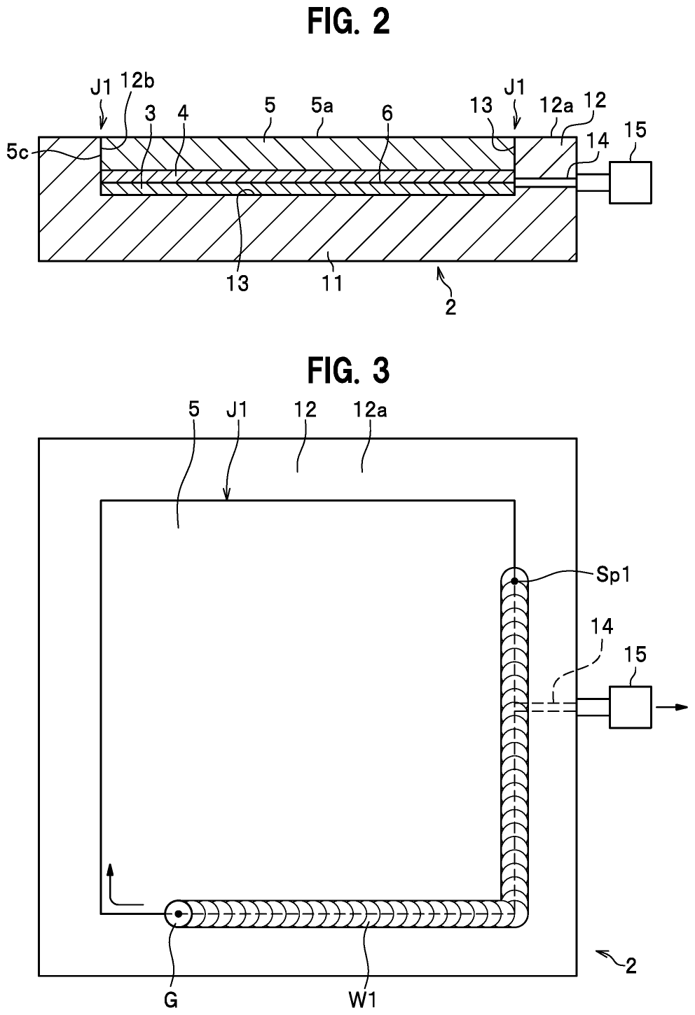

The intermediate members 3, 4 are metal members each of which has a rectangular plate shape. The intermediate members 3, 4 are accommodated in the recessed portion 13 as shown in FIG. 2. The intermediate members 3, 4 are composed of two plates in the embodiment, but may be composed of one plate or more than two plates. Each of the intermediate members 3, 4 is made of copper or a copper alloy in the embodiment. And one of the intermediate members 3, 4 is made of the same kind of material as the other in the embodiment, but may be made of a different kind of material different from that of the other. Materials of the intermediate members 3, 4 are appropriately selected from among materials different from at least one of the box body 2 and the sealing body 5. That is, one plate or plural plates is or are inserted into the box body 2 as an intermediate member of the present invention, and the one plate or at least one of the plates as the intermediate member is or are made of material(s) different from at least one of the box body 2 and the sealing body 5. Furthermore, thicknesses of the intermediate members 3, 4 are the same as each other in the embodiment, but may be different from each other.

A remover (or a removing member) 6 is interposed between the intermediate members 3, 4. For example, the remover LBN (made by Showa Denko K. K.) can be used as the remover 6. The aluminum alloy A5083-O of a thin plate can be used as the removing member. The removing member contains 2 mass % or more of Mg. Furthermore, a thin plate member made of aluminum or an aluminum alloy, at least one of a front face and a back face of which anodic oxidation has been applied on, can be used as the removing member.

The remover 6 or the removing member is used to divide (peel off) the members between which the remover 6 or the removing member is located, the members having been formed by applying a rolling process or a forging process to the composite slab 1. Material and characteristics of the remover 6 or the removing member may be appropriately selected according to materials of the intermediate members 3, 4 and conditions of the rolling process or the forging process.

The sealing body 5 is a metal member having a rectangular plate shape. As shown in FIG. 2, the sealing body 5 is a member that is accommodated in the recessed portion 13 and covers the intermediate member 4 from an upper side. A front face 5a of the sealing body 5 is flush with a peripheral wall end face 12a of the peripheral wall portion 12. The sealing body 5 is joined to the box body 2 over the entire circumference. Welding (TIG welding, MIG welding, laser welding, or the like), friction stir welding, or the like can be used as the joining method and the joining method is not specifically limited as far as closing can be done. Material of the sealing body 5 is not specifically limited and in the embodiment, it is made of aluminum or an aluminum alloy. Note that, members like the box body 2 and the sealing body 5 to cover over the intermediate members 3, 4 are referred to also “closing member”.

Next, a method for manufacturing a composite slab will be explained. In the method for manufacturing a composite slab according to the embodiment, a preparation process, a butting process, an evacuation process, a closing process, and a blocking process are performed.

The preparation process is a process to prepare the box body 2, the intermediate members 3, 4, the sealing body 5, and the like. The evacuation jig 15 is beforehand connected to the peripheral wall portion 12 of the box body 2 to communicate with the exhaust channel 14.

As shown in FIG. 2, the butting process is a process to accommodate the intermediate members 3, 4 in the box body 2 and butt the sealing body 5 against the box body 2. The intermediate members 3, 4 are arranged in the recessed portion 13 almost without gap. Abutted portion J1 is formed by butting a side face 5c of the sealing body 5 against an inner face 12b of the peripheral wall portion 12. As the result, the front face 5a of the sealing body 5 becomes flush with the peripheral wall end face 12a of the peripheral wall portion 12.

The evacuation process is a process in which the inside defined by the sealing body 5 and the box body 2 is evacuated to become vacuum. The evacuation process is performed in a state of connecting an evacuation device not shown with the evacuation jig 15. The evacuation process may be performed before or after performing the closing process, or continuously performed since before beginning of the closing process until the blocking process is finished. Furthermore, the evacuation process may be omitted.

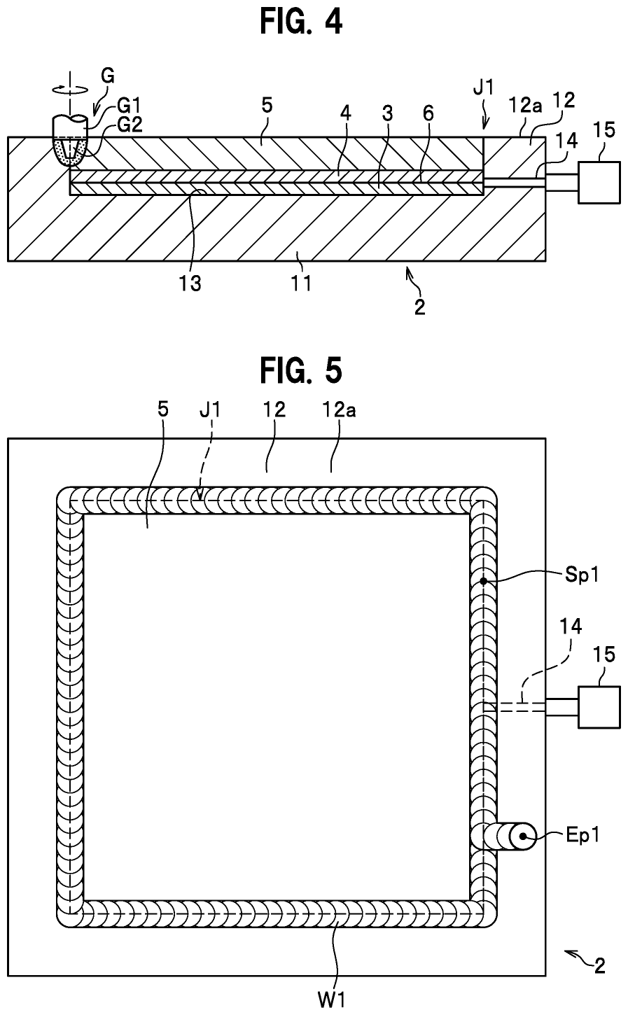

As shown in FIGS. 3 to 5, the closing process is a process in which closing is done by joining the box body 2 and the sealing body 5 together. The joining method in the closing process is not particularly limited as far as the sealing body 5 can be joined to the box body 2 so that the sealing body 5 can close the box body 2. In the embodiment, the closing is done by friction stir welding. As shown in FIG. 4, a first rotary tool G provided with a shoulder portion G1 and a stirring pin G2 is used in the closing process. In the closing process, as shown in FIG. 5, the first rotary tool G which is rotating clockwise is inserted into the butted portion J1 at a start position Sp1 set on the butted portion J1 and moved along the butted portion J1. Thus, a plasticized region W1 is formed along a moving track of the first rotary tool G. As shown in FIG. 4, in the closing process, friction stirring is performed in a state where a lower end face of the shoulder portion G1 is slightly pushed into the peripheral wall end face 12a and the front face 5a of the sealing body 5 and the stirring pin F2 does not come into contact with the intermediate member 4. An insertion depth of the first rotary tool G may be appropriately set, and it is preferable that it is set so that different kinds of materials are not mixed while friction stirring is performed like the embodiment.

As shown in FIG. 5, after having moved the first rotary tool G one lap while a starting edge and an ending edge of the plasticized region W1 are overlapped, the first rotary tool G is pulled out from the peripheral wall end face 12a at an end position Epi set on the peripheral wall end face 12a.

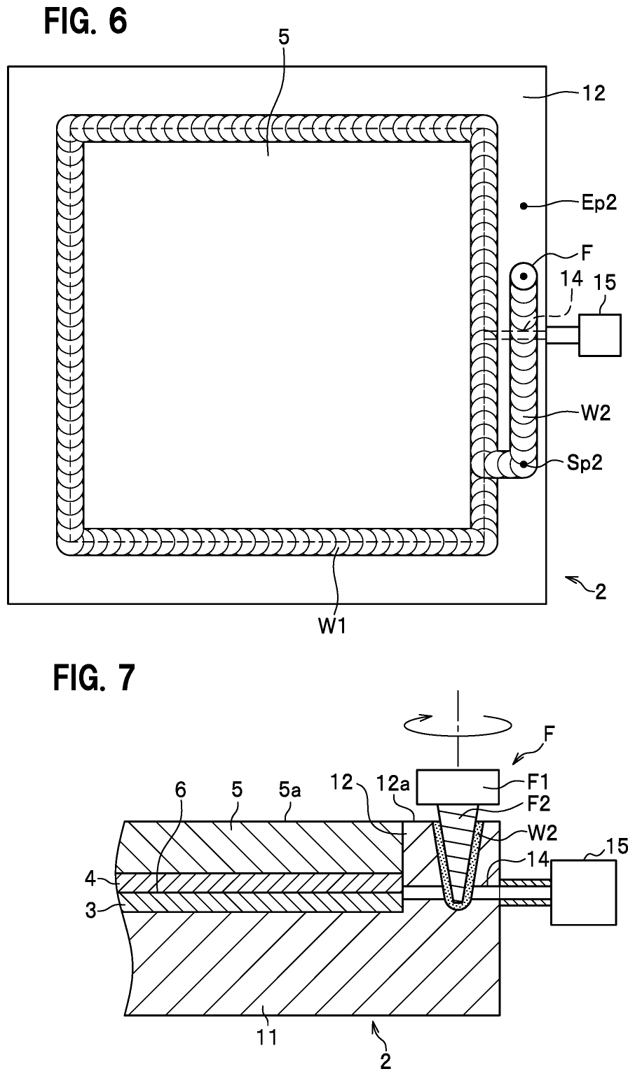

As shown in FIGS. 6 and 7, the blocking process is a process to block flowing through the exhaust channel 14. In the embodiment, it is blocked by friction stir welding with use of a second rotary tool F. The second rotary tool F has a connecting portion F1 and a stirring pin F2. The second rotary tool F is made of tool steel or the like. The connecting portion F1 is a portion to be connected to a rotary shaft of a friction stir device not shown. The connecting portion F1 has a cylindrical shape and a thread hole (not shown) into which a bolt is fastened.

The stirring pin F2 hangs down from and is coaxial with the connecting portion F1. The stirring pin F2 has a smaller diameter with increasing distance from the connecting portion F1. The stirring pin F2 has a spiral groove formed on the outer circumferential face thereof. In the embodiment, since the second rotary tool F is rotated clockwise, the spiral groove is formed to rotate counterclockwise with increasing distance from the base end toward the tip. In other words, the spiral groove is formed to rotate counterclockwise with increasing distance from the base end toward the tip when it is viewed from the upper side.

Note that, in a case where the second rotary tool F is rotated counterclockwise, it is preferable that the spiral groove is formed to rotate clockwise with increasing distance from the base end toward the tip. In other words, the spiral groove of this case is formed to rotate clockwise with increasing distance from the base end toward the tip when it is viewed from the upper side. By forming the spiral groove in such a manner, plastically fluidized metal formed by friction stirring is led toward the tip of the stirring pin F2 through the spiral groove. By this, the amount of metal to leak out of the box body 2 can be reduced.

As shown in FIG. 6, in the blocking process, the second rotary tool F rotating clockwise is inserted into the peripheral wall end face 12a at a start position Sp2 set on the peripheral wall end face 12a, and moved to an end position Ep2 set on the opposite side of the start position Sp2 with reference to the exhaust channel 14. That is, the second rotary tool F is moved in a direction perpendicular to the exhaust channel 14. As shown in FIG. 7, the second rotary tool F is moved while keeping the tool F with such an insertion depth that only the stirring pin F2 is in contact with the peripheral wall portion 12, that is, moved in a state where the base end portion of the stirring pin F2 is exposed. Furthermore, in the blocking process, the insertion depth of the second rotary tool F is set so that the stirring pin F2 reaches the exhaust channel 14.

Note that, the blocking process may be performed with use of the same rotary tool as that in the closing process. In that case, the closing process and the blocking process can be continuously performed. Furthermore, the blocking process may be performed, for example, by plastically deforming the peripheral wall portion 12 to crush the exhaust channel 14. And furthermore, the blocking process may be performed by pushing a filler or a filling member into the exhaust channel 14 to block it.

Through all the processes described in the above, the composite slab 1 is completed. And after the blocking process, a deburring process to remove burrs existing on the surfaces of the box body 2 and the sealing body 5 may be performed.

After the composite slab 1 is completed, the rolling process is performed to make a plural layer clad material. In the rolling process, the composite slab 1 is rolled with use of a rolling device (not shown) provided with rolling rollers. In the rolling process according to the embodiment, the hot rolling is performed in a state where the temperature of the atmosphere is set to, for example, about 500° C. In this way, the bottom portion 11 of the box body 2 and the intermediate member 3 are joined together and the sealing body 5 and the intermediate member 4 are joined together. On the other hand, since the remover 6 or a removing member is interposed between the intermediate members 3, 4, the intermediate members 3, 4 are not joined together even by the hot rolling. The temperature during the hot rolling process may be appropriately set according to metal material. For example, the hot rolling is performed at 460° C. to 600° C., and it is preferable that the hot rolling is performed at 470° C. to 550° C. The temperature during the hot rolling process may be appropriately set in the range where the bottom portion 11 of the box body 2 and the intermediate member 3 are joined together, the sealing body 5 and the intermediate member 4 are joined together and the intermediate members 3, 4 are not joined together in a case where the remover 6 or a removing member is used like the embodiment.

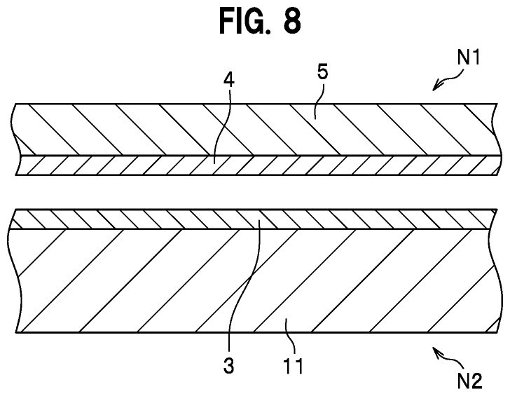

After the composite slab 1 comes to have a desired thin thickness, as shown in FIG. 8, the intermediate members 3, 4 are divided (peeled off) with the remover (remover 6 shown in FIG. 2) applied between the intermediate members 3, 4 being the boundary. In this way, plural layer clad materials N1, N2, which are made of copper or a copper alloy; and aluminum or an aluminum alloy, can be obtained. Note that, a plural layer clad material may be made by forging the composite slab 1 with replacement of rolling the same.

Since the intermediate members 3, 4 are closed in the inside defined by the box body 2 and the sealing body 5 according to a method for manufacturing a composite slab according to the embodiment described in the above, the closing process can be easily done. That is, since positioning the intermediate members 3, 4 and the sealing body 5 relative to the box body 2 can be easily done, friction stir welding can also be easily performed. Furthermore, a method for the closing process is not specifically limited, but the joining can be easily done by using friction stir welding as the method.

The composite slab 1 having the vacuum inside can be formed by performing the evacuation process. Thus, an oxide film can be prevented from being generated in each of the plural layer clad materials N1, N2 when the plural layer clad materials N1, N2 are made through the rolling process or forging process. Further, the vacuum state in the composite slab 1 can be kept by performing the blocking process. And furthermore, the exhaust channel 14 can be easily blocked since the blocking process is performed by friction stirring.

Since the remover 6 is interposed between the intermediate members 3, 4 of the composite slab 1, the intermediate members 3, 4 are peeled off at the border between the intermediate members 3, 4 after the rolling or forging process is performed, so that the plural layer clad materials N1, N2, which are made of copper or a copper alloy; and aluminum or an aluminum alloy, can be manufactured. That is, the bottom portion 11 of the box body 2 and the intermediate member 3 are joined together and the intermediate member 4 and the sealing body 5 are joined together by performing the rolling process, but the intermediate members 3, 4 are prevented from being joined together because of the intervention of the remover 6. Thus, the plural layer clad materials N1, N2 can be made by removing the both members at the border of the remover 6. Therefore, the productivity can be enhanced.

The embodiment of the present invention has been explained in the above, but design changes can be appropriately done within the range of the purpose of the present invention. Furthermore, the “closing member” composed of the box body 2 and the sealing body 5 in the foresaid embodiment is an example and not specifically limited. Any embodiments are allowed as far as it can make the inside thereof vacuum and accommodates the intermediate members 3, 4. And furthermore, the butting form is not specifically limited either in the case. For example, a pair of box bodies or plural plate like members may cover the intermediate members. Further, the exhaust channel 14 may be formed at a portion of the “closing member”, and for example, at the bottom portion 11, the sealing body 5 or the like.

The remover 6 or a removing member is not necessary to be used. For example, if the remover 6 or a removing member is not used in the first embodiment, the intermediate members 3 and 4 are also joined together through the hot rolling process to manufacture a plural layer clad material composed of three layers of Al/Cu/Al.

### Second Embodiment

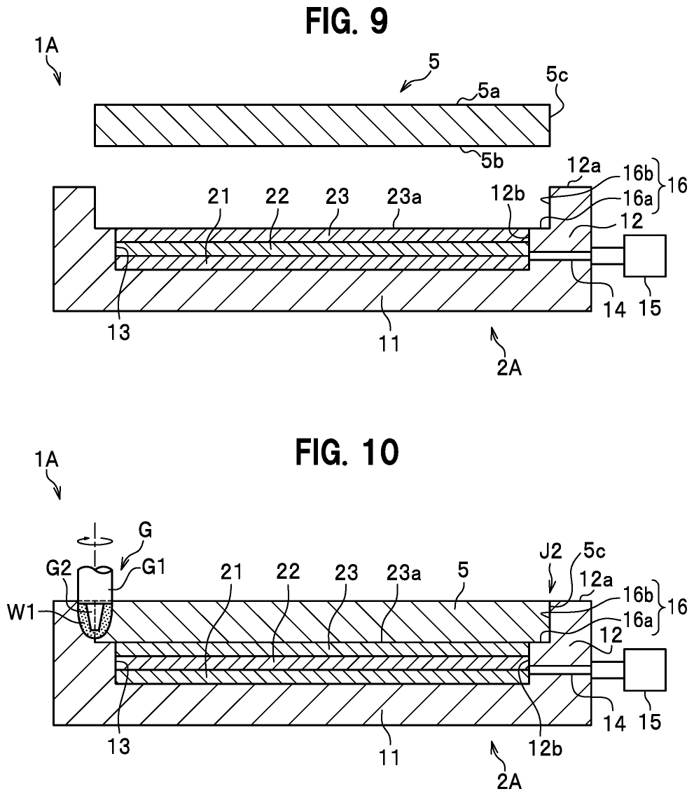

Next, a method for manufacturing a composite slab according to a second embodiment of the present invention will be explained. As shown in FIG. 9, the method for manufacturing a composite slab according to the second embodiment differs from the first embodiment in the points of the number of intermediate members and a butting form. In this embodiment, differences from the first embodiment will be mainly explained.

In the method for manufacturing a composite slab according to the second embodiment, a preparation process, a butting process, an evacuation process, a closing process, and a blocking process are performed. As shown in FIG. 9, in the preparation process, a box body 2, the sealing body 5, and intermediate members 21 to 23 are prepared.

A step portion 16 is formed along an inner edge of the peripheral wall portion 12 of the box body 2A made of aluminum or an aluminum alloy. The step portion 16 is defined by a step bottom face 16a and a step side face 16b standing on the step bottom face 16a. The intermediate members 21, 22, 23 are members to be accommodated in the recessed portion 13 of the box body 2A. Materials and thicknesses of the intermediate members 21, 22, 23 may be appropriately selected. The intermediate members 21, 22, 23 may be of the same material (for example, copper or a copper alloy) as one another, or respectively of different materials. Furthermore, it may be that the intermediate members 21, 22 are of the same material as each other and the intermediate member 23 is of a material different from the intermediate members 21, 22. In this embodiment, as an example, the intermediate members 21, 23 are of copper or a copper alloy, and the intermediate member 22 is of aluminum or an aluminum alloy. The remover or the removing member may be appropriately interposed between each adjacent two of the intermediate members, between the bottom portion 11 and the intermediate member 21, or between the sealing body 5 and the intermediate member 23 according to a desired plural layer clad material. The plate thickness of the sealing body 5 made of aluminum or an aluminum alloy is the same as the height dimension of the step side face 16b.

As shown in FIG. 10, the butting process is a process in which the intermediate members 21 to 23 are accommodated in the recessed portion 13 of the box body 2 and the recessed portion is sealed with the sealing body 5. A front face 23a of the intermediate member 23 being the top member is flush with the step bottom face 16a. A butted portion J2 is formed by butting a side face 5c of the sealing body 5 against the step side face 16b. The evacuation process, the closing process and the blocking process are the same as those in the first embodiment. Thus, a composite slab 1A is manufactured.

The method for manufacturing a composite slab according to the second embodiment mentioned in the above has almost the same effect as the first embodiment. Furthermore, the three intermediate members 21, 22, 23 may be used like the second embodiment. Furthermore, the sealing body 5 may be butted against the step portion 16 to be formed on the box body 2A.

### Third Embodiment

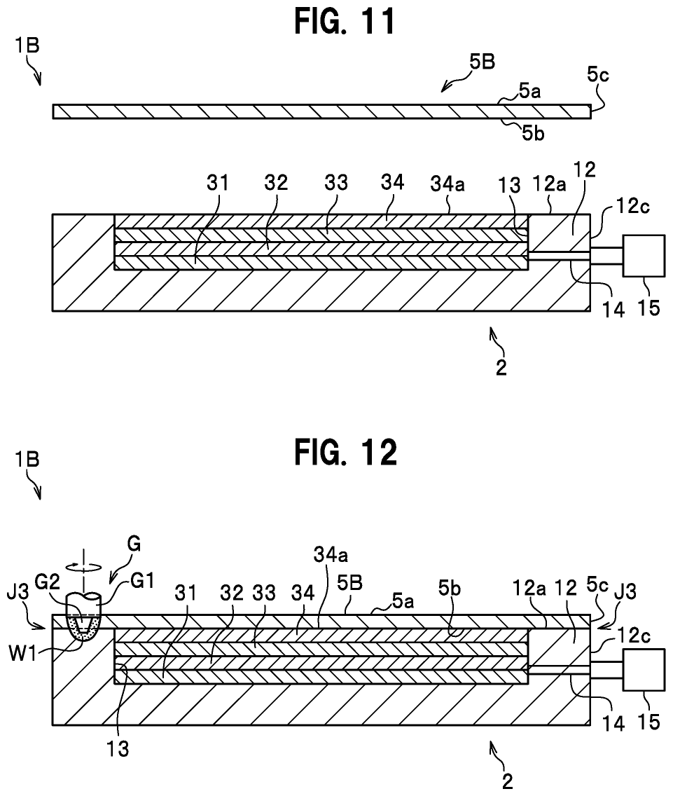

Next, a method for manufacturing a composite slab according to a third embodiment of the present invention will be explained. As shown in FIG. 11, in the method for manufacturing a composite slab according to the third embodiment, the number of intermediate members and a butting form differ from those in the first embodiment. In this embodiment, differences from the first embodiment will be mainly explained.

In the method for manufacturing a composite slab according to the third embodiment, a preparation process, a butting process, an evacuation process, a closing process, and a blocking process are performed. As shown in FIG. 11, in the preparation process, the box body 2, a sealing body 5B and intermediate members 31 to 34 are prepared.

The intermediate members 31 to 34 are members to be accommodated in the recessed portion 13 of the box body 2. Materials and plate thicknesses of the intermediate members 31 to 34 may be appropriately selected. The intermediate members 31 to 34 may be of the same material (for example, copper or a copper alloy) as one another, or respectively of different materials. Furthermore, it may be that two or more of the intermediate members 31 to 34 are of the same material as each other and the other (s) is (are) of a material different from the two or more. In this embodiment, as an example, the intermediate members 31, 33 are of copper or a copper alloy, and the intermediate members 32, 34 are of aluminum or an aluminum alloy. The remover or the removing member may be appropriately interposed between each adjacent two of the intermediate members, between the bottom portion 11 and the intermediate member 31, or between the sealing body 5B and the intermediate member 34 according to a desired plural layer clad material. The size of the sealing body 5B is the same as that of the box body 2.

The butting process is a process in which the intermediate members 31 to 34 are accommodated in the recessed portion 13 of the box body 2, and the recessed portion is sealed with use of the sealing body 5B. A front face 34a of the intermediate member 34 being the top member is flush with the peripheral wall end face 12a. A butted portion J3 is formed by butting a back face 5b of the sealing body 5 against the peripheral wall end face 12a. A side face 5c of the sealing body 5 is flush with an outer side face 12c of the peripheral wall portion 12. The evacuation process is the same as that in the first embodiment.

In the closing process, the butted portion J3 is joined by friction stir welding with use of the first rotary tool G to close the portion. In the closing process, the first rotary tool G rotating clockwise is inserted into the sealing body 5 from the front face 5a thereof, and moved one lap along the butted portion J3. An insertion depth of the first rotary tool G is set so that the stirring pin G2 reaches the peripheral wall portion 12. After a starting edge and an ending edge of a plasticized region W1 are overlapped, the first rotary tool G is pulled out from the sealing body 5. The blocking process is the same as that in the first embodiment. Thus, a composite slab 1B is manufactured.

The method for manufacturing a composite slab according to the third embodiment mentioned in the above has almost the same effect as the first embodiment. Furthermore, the four intermediate members 31, 32, 33, 34 may be used like the third embodiment. Furthermore, the butted portion J3 may be formed so that the sealing body 5B is overlapped on the peripheral wall end face 12a like the third embodiment.

### Fourth Embodiment

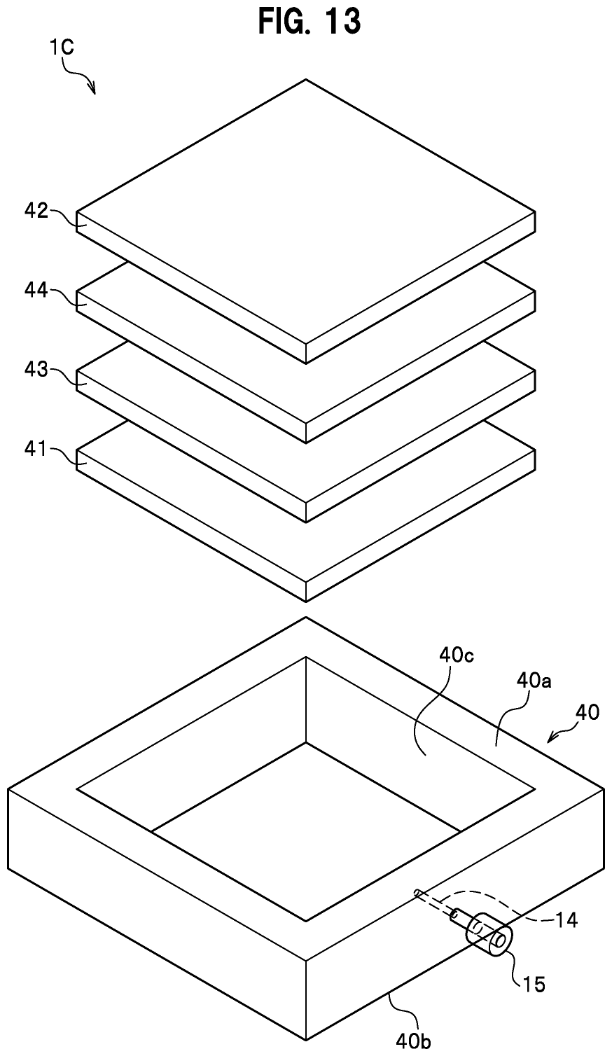

Next, a method for manufacturing a composite slab according to a fourth embodiment of the present invention will be explained. As shown in FIG. 13, the method for manufacturing a composite slab according to the fourth embodiment differs from the first embodiment in that a frame member 40 is used. In this embodiment, differences from the first embodiment will be mainly explained.

In the method for manufacturing a composite slab according to the fourth embodiment, a preparation process, a butting process, an evacuation process, a closing process, and a blocking process are performed. As shown in FIG. 13, the preparation process is a process in which the frame member 40, a bottom member 41, a sealing body 42 and intermediate members 43, 44 are prepared. The “closing member” is composed of the frame member 40, the bottom member 41 and the sealing body 42.

The frame member 40 has a rectangular frame shape. A material of the frame member 40 is not specifically limited, and in this embodiment, it is made of aluminum or an aluminum alloy. The bottom member 41 and the sealing body 42 are rectangular plate members. The exhaust channel 14 passing through in an inside and outside direction is formed in the frame member 40. The evacuation jig 15 is installed to communicate with the exhaust channel 14. The bottom member 41 and the sealing body 42 are formed to have sizes to be arranged inside the frame member 40 almost without gaps. Materials of the bottom member 41 and the sealing body 42 are not specifically limited, and in this embodiment, they are made of aluminum or an aluminum alloy.

The intermediate members 43, 44 are members to be accommodated inside the “closing member” and are rectangular plate members. The intermediate members 43, 44 are formed to have sizes to be arranged inside the frame member 40 almost without gaps. Materials of the intermediate members 43, 44 are not specifically limited, and in this embodiment, they are made of copper or a copper alloy. Materials of the intermediate members 43, 44 are appropriately selected from materials different from at least one of the bottom member 41 and the sealing body 42. In other words, one intermediate member or plural intermediate members of the present invention is/are inserted inside the frame member 40, and at least one of the intermediate members is to be made of a material different from at least one of the bottom member 41 and the sealing body 42. Remover or a removing member may be interposed between the intermediate members 43, 44. The thickness of the intermediate members 43, 44 may be appropriately set.

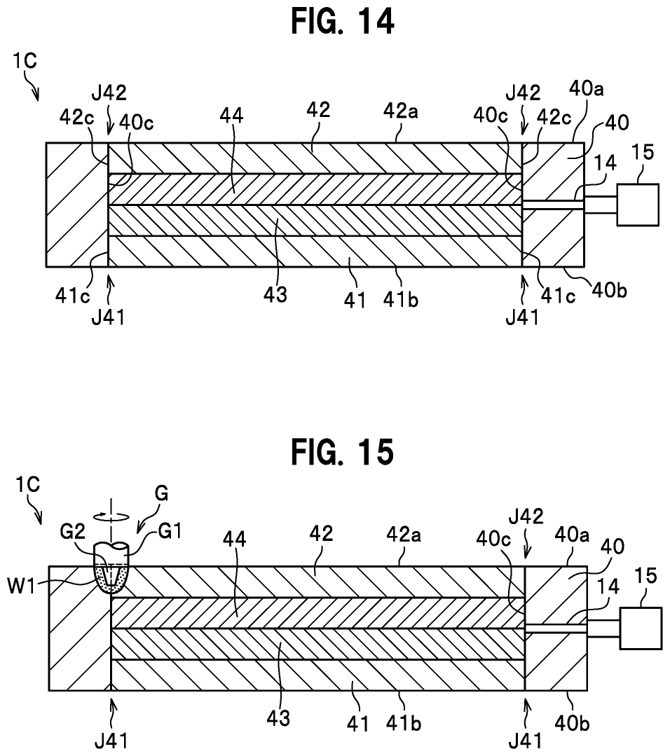

As shown in FIG. 14, the butting process is a process in which the frame member 40, the bottom member 41, the sealing body 42 and the intermediate members 43, 44 are butted to form butted portions J41, J42. In the butting process, the bottom member 41, the intermediate members 43, 44, and the sealing body 42 are arranged inside the frame member 40 in this order. A side face 41c of the bottom member 41 and an inner side face 40c of the frame member 40 are butted against each other to form the butted portion J41. A side face 42c of the sealing body 42 and the inner side face 40c of the frame member 40 are butted against each other to form the butted portion J42. A back face 41b of the bottom member 41 is flush with a frame end face 40b. Further, a front face 42a of the sealing body 42 is flush with a frame end face 40a. Each of the butted portions J41, J42 has a rectangular frame shape. The evacuation process is the same as that in the first embodiment.

The closing process is a process in which each of the bottom member 41 and the sealing body 42 is joined to the frame member 40 to close them. As shown in FIG. 5, in the closing process, friction stir welding is performed by inserting the first rotary tool G being rotated into the butted portion J42. After the first rotary tool G is moved one lap along the butted portion J42, a starting edge and an ending edge of a plasticized region W1 are overlapped, and the first rotary tool G is pulled out from the frame end face 40a.

Furthermore, in the closing process, friction stir welding is performed by inserting the first rotary tool G being rotated into the butted portion J41. After the first rotary tool G is moved one lap along the butted portion J41, a starting edge and an ending edge of a plasticized region W1 are overlapped, and the first rotary tool G is pulled out from the frame end face 40b. The blocking process is the same as that in the first embodiment. Thus, a composite slab 1C is manufactured.

The method for manufacturing a composite slab according to the fourth embodiment mentioned in the above has almost the same effect as the first embodiment. In the first embodiment, the box body 2 is used, but even though in a case where the frame member 40 is used like in this embodiment, the bottom member 41, the sealing body 42 and the intermediate members 43, 44 can be accommodated inside the frame member 40, so that positioning works and the closing process can be easily performed.

### Fifth Embodiment

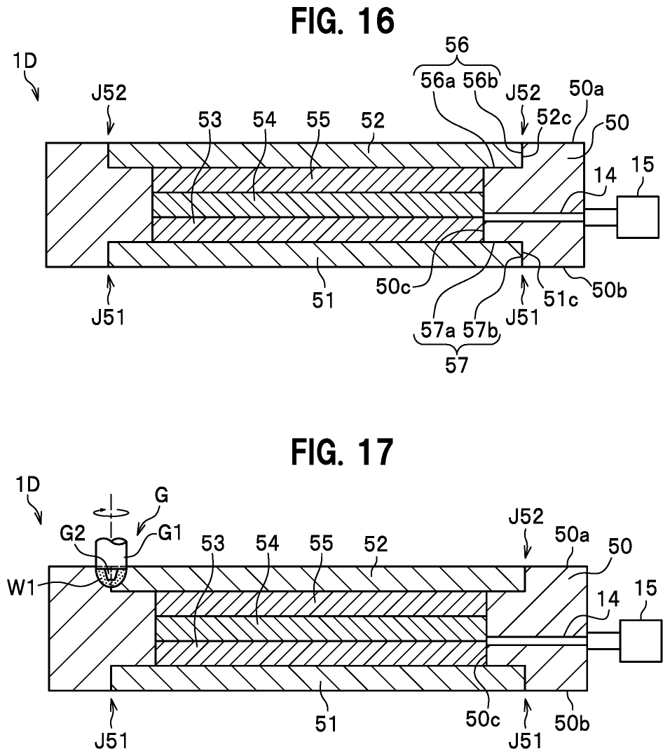

Next, a method for manufacturing a composite slab according to a fifth embodiment of the present invention will be explained. As shown in FIG. 16, the method for manufacturing a composite slab according to the fifth embodiment differs from the fourth embodiment in the points of the number of intermediate members and a butting form. In this embodiment, differences from the fourth embodiment will be mainly explained.

In the method for manufacturing a composite slab according to the fifth embodiment, a preparation process, a butting process, an evacuation process, a closing process, and a blocking process are performed. As shown in FIG. 16, in the preparation process, a frame member 50, a bottom member 51, a sealing body 52 and intermediate members 53, 54, 55 are prepared.

Step parts 56, 57 are formed along an upper portion and a lower portion of an inner side face 50c of the frame member 50 made of aluminum or an aluminum alloy. The step portion 56, which is formed at the upper portion of the frame member 50, is defined by a step bottom face 56a and a step side face 56b standing on the step bottom face 56a. The step portion 57, which is formed at the lower portion of the frame member 50, is defined by a step bottom face 57a and a step side face 57b standing on the step bottom face 57a.

The intermediate members 53, 54, 55 are members to be accommodated inside the frame member 50. Materials and thickness of the intermediate members 53, 54, 55 may be appropriately selected. The intermediate members 53, 54, 55 all may be of one material (for example, copper or a copper alloy), or each may be of a material different from one another. Furthermore, it is allowed that the intermediate members 53, 55 are of the same material as each other and the intermediate member 54 is different from the other two. In this embodiment, for example, the intermediate members 53, 55 are made of copper or a copper alloy, and the intermediate member 54 is made of aluminum or an aluminum alloy. Remover or a removing member may be appropriately interposed between each adjacent two of the intermediate members, between the bottom member 51 and the intermediate member 53, or between the sealing body 52 and the intermediate member 55 according to a desired plural layer clad material.

As shown in FIG. 17, in the butting process, the bottom member 51 is arranged on the step portion 57 of the frame member 50, and the intermediate members 53, 54, 55 are arranged inside the frame member 50. Furthermore, the sealing body 52 is placed on the step portion 56 of the frame member 50 to seal. A side face 52c of the sealing body 52 and the step side face 56b of the step portion 56 are butted against each other to form a butted portion J52. A side face 51c of the bottom member 51 and the step side face 57b of the step portion 57 are butted against each other to forma butted portion J51. Each of the butted portions J51, J52 is formed to have a rectangular frame shape. The evacuation process, the closing process and the blocking process are the same as those in the fourth embodiment. Thus, a composite slab 1D is manufactured.

The method for manufacturing a composite slab according to the fifth embodiment mentioned in the above has almost the same effect as the fourth embodiment. Three intermediate members 53, 54, 55 may be used like the fifth embodiment. The bottom member 51 and sealing body 52 may be butted against the step parts 57, 56 to be formed on the frame member 50, respectively like the fifth embodiment.

### Sixth Embodiment

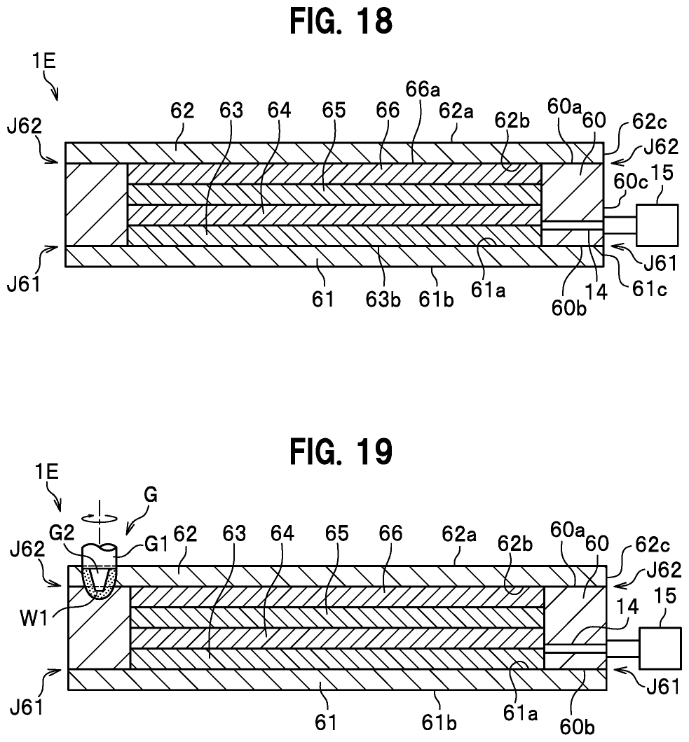

Next, a method for manufacturing a composite slab according to a sixth embodiment of the present invention will be explained. As shown in FIG. 18, the method for manufacturing a composite slab according to the sixth embodiment differs from the fourth embodiment in the points of the number of intermediate members and a butting form. In this embodiment, differences from the fourth embodiment will be mainly explained.

In the method for manufacturing a composite slab according to the sixth embodiment, a preparation process, a butting process, an evacuation process, a closing process, and a blocking process are performed. As shown in FIG. 18, in the preparation process, a frame member 60, a bottom member 61, a sealing body 62 and intermediate members 63 to 66 are prepared.

The frame member 60 is made of aluminum or an aluminum alloy and has a rectangular frame shape. The bottom member 61 and the sealing body 62 are made of aluminum or an aluminum alloy and each has substantially the same size as the frame member 60.

The intermediate members 63 to 66 are members to be accommodated inside the frame member 60. Materials and thicknesses of the intermediate members 63 to 66 may be appropriately selected. The intermediate members 63 to 66 all may be of one material (for example, copper or a copper alloy), or each may be of a material different from one another. Furthermore, it is allowed that two or more of the intermediate members 63 to 66 are of the same material as each other and the other or the others is/are of a different material or different materials. In this embodiment, for example, the intermediate members 63, 65 are made of copper or a copper alloy, and the intermediate members 64, 66 are made of aluminum or an aluminum alloy. Remover or a removing member may be appropriately interposed between each adjacent two of the intermediate members, between the bottom member 61 and the intermediate member 63, or between the sealing body 62 and the intermediate member 66 according to a desired plural layer clad material.

In the butting process, the frame member 60 is arranged on the bottom member 61, the intermediate members 63 to 66 are arranged inside the frame member 60, and the sealing body 62 is arranged on the intermediate member 66 and the frame member 60. A front face 66a of the intermediate member 66 and a frame end face 60a are flush with each other, and a back face 63b of the intermediate member 63 and a frame end face 60b are flush with each other. A butted portion J62 is formed by butting a back face 62b of the sealing body 62 and the frame end face 60a against each other. Furthermore, a butted portion J61 is formed by butting a front face 61a of the bottom member 61 and the frame end face 60b against each other. A side face 61c of the bottom member 61, a side face 62c of the sealing body 62, and a side face 60c of the frame member 60 are flush with one another.

As shown in FIG. 19, in the closing process, the butted portions J61, J62 are joined to close them by friction stir welding with use of the first rotary tool G. In the closing process, the first rotary tool G rotating clockwise is inserted from a front face 62a of the sealing body 62, and moved one lap along the butted portion J62. An insertion depth of the first rotary tool G is set so that the stirring pin G2 reaches the frame member 60. A starting edge and an ending edge of a plasticized region W1 are overlapped, and then, the first rotary tool G is pulled out of the sealing body 62. Friction stir welding is performed also to the butted portion J61 like to the butted portion J62. The blocking process is the same as that in the first embodiment. In such a manner, a composite slab 1E is manufactured.

The method for manufacturing a composite slab according to the sixth embodiment mentioned in the above has almost the same effect as the fourth embodiment. Furthermore, the four intermediate members 63, 64, 65, 66 may be used like the sixth embodiment. And further, the butted portions J61, J62 may be formed by overlapping the bottom member 61 and the sealing body 62 on the frame member 60 like the sixth embodiment.

### EXAMPLES

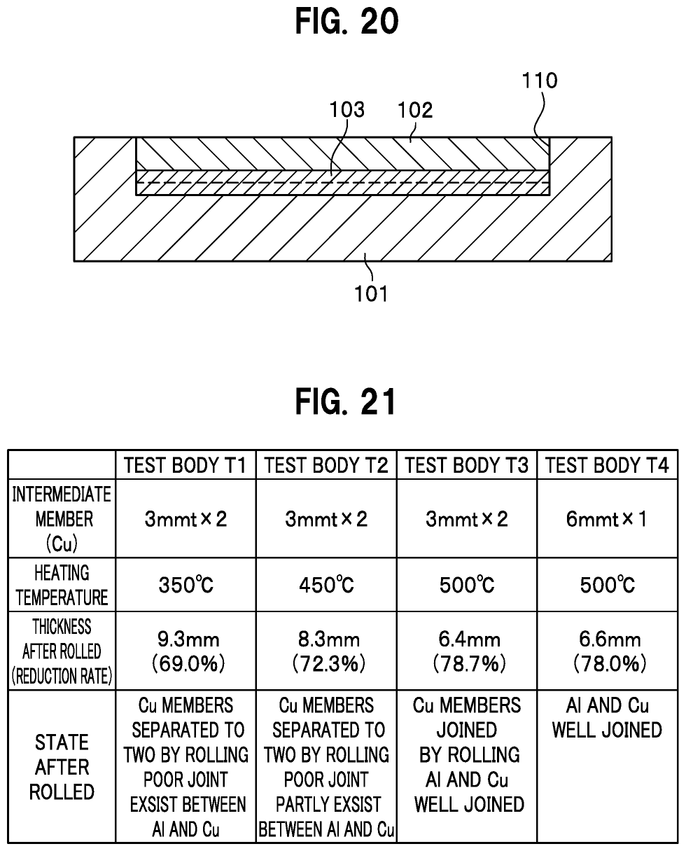

Next, an example of the present invention will be explained. FIG. 20 is a schematic cross sectional view showing a test body of an example. In this example, after manufacturing a composite slab, a hot rolling process is performed to the slab, and finally, a plural layer clad material composed of two layers of Al/Cu is manufactured and confirming the joined state and so on is intended.

In the example, four sorts of test bodies T1, T2, T3, T4 of composite slabs of the present invention are made. As shown in FIG. 20, each test body is formed of a box body 101, a sealing body 102, and an intermediate member 103. The intermediate member 103 is composed of one plate or two plates. The box body 101 is made of the aluminum alloy A1050. The whole plate thickness of the box body 101 is 30 mm, and the depth of a recessed portion 110 is 14 mm.

The intermediate member 103 is made of the copper alloy C1020. As shown in FIG. 21, the intermediate member 103 is composed of two plates, each plate having a thickness of 3 mm, in the test bodies T1, T2, T3. The intermediate member in the test body T4 is composed of one plate having a thickness of 6 mm. The sealing body 102 is made of the aluminum alloy A1050, and has a thickness of 8 mm.

Each composite slab was manufactured from the test bodies T1 to T4 by the same method as that of the first embodiment. As shown in FIG. 21, after that, a hot rolling process was performed to each to make it thin to a desired thickness. Regarding the heating temperature during a hot rolling process for each test body, it is about 350° C. for the test body T1, about 450° C. for the test body T2, and about 500° C. for the test bodies T3, T4.

The thickness of the test body T1 became 9.3 mm (the reduction rate is 69.0%) by the hot rolling process. By the hot rolling process, plates of the intermediate member 103, 103 of the test body T1 were not joined together but separated. There existed poor joint between Al and Cu (that is, between the box body 101 and the intermediate member 103, and between the sealing body 102 and the intermediate member 103).

The thickness of the test body T2 became 8.3 mm (the reduction rate is 72.3%) by the hot rolling process. By the hot rolling process, plates of the intermediate member 103, 103 of the test body T2 were not joined together but separated. There partly existed poor joint between Al and Cu (that is, between the box body 101 and the intermediate member 103, and between the sealing body 102 and the intermediate member 103).

The thickness of the test body T3 became 6.4 mm (the reduction rate is 78.7%) by the hot rolling process. By the hot rolling process, both copper plates of the intermediate member 103, 103 of the test body T3 were well joined together. Furthermore, Al and Cu (that is, the box body 101 and the intermediate member 103, and the sealing body 102 and the intermediate member 103) were also well joined together.

The thickness of the test body T4 became 6.6 mm (the reduction rate is 78.0%) by the hot rolling process. By the hot rolling process, Al and Cu (that is, the box body 101 and the intermediate member 103, and the sealing body 102 and the intermediate member 103) of the test body T4 were well joined together.

As shown by the results of the test bodies T1, T2, it was proved that in a case where the heating temperature during a hot rolling process is equal to or less than 450° C., a good plural layer clad material cannot be manufactured because Al and Cu cannot originally be joined. On the other hand, as shown by the results of the test bodies T3, T4, in a case where the heating temperature during a hot rolling process is 500° C., Al and Cu were well joined. However, as shown by the result of the test body T3, Cu and Cu (both plates of the intermediate member 103, 103) also result in being joined together, so that a plural layer clad material of Al/Cu/Al is manufactured. That is, a plural layer clad material of three layers is manufactured rather than the desired two layers. Similarly, since the intermediate member 103 of the test body T4 is composed of one plate, a plural layer clad material of three layers of Al/Cu/Al results in being manufactured.

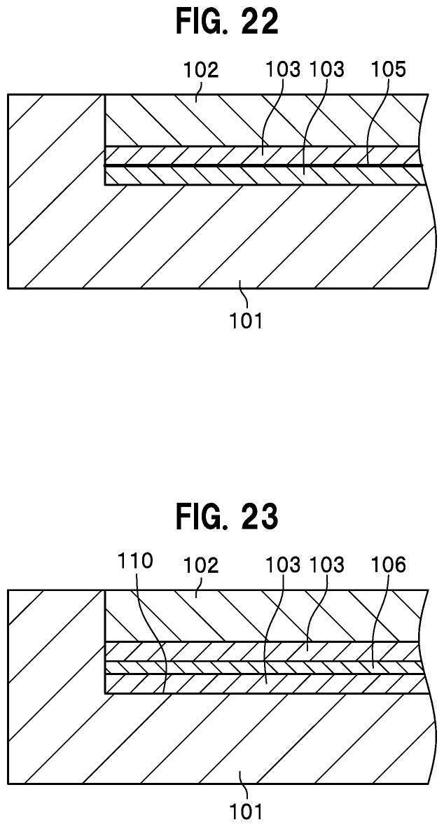

FIG. 22 is a cross sectional view showing a test body T5. As shown in FIG. 22, a remover 105 is interposed between the two intermediate members 103, 103 in the test body T5. The remover 105 is the remover LBN (made by Showa Denko K.K.). Each dimension of the test body T5 is the same as that of the test body T1.

FIG. 23 is a cross sectional view showing a test body T6. As shown in FIG. 23, a removing member 106 is interposed between two intermediate members 103, 103 of the test body T6. The removing member 106 is made of the aluminum alloy A5083-O of a thin plate.

The removing member 106 contains 2 mass % or more of Mg. Since the thickness of the removing member 106 of the test body T6 is 2.0 mm, the depth of a recessed portion 110 is 16 mm.

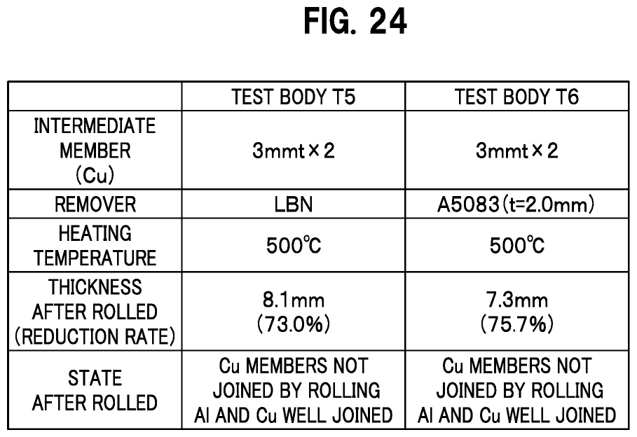

Each composite slab is manufactured from the test bodies T5 and T6 by the same method as that of the first embodiment. After that, a hot rolling process was performed to each to make it thin to a desired thickness. As shown in FIG. 24, the heating temperature during a hot rolling process for each of the test bodies T5, T6 was about 500° C.

As shown in FIG. 24, the thickness of the test body T5 became 8.1 mm (the reduction rate is 73.0%) by the hot rolling process. By the hot rolling process, Al and Cu (that is, between the box body 101 and the intermediate member 103, and between the sealing body 102 and the intermediate member 103) of the test body T5 were well joined together. On the other hand, both plates of the intermediate member 103, 103 were not joined together because the remover 105 is interposed between them.

As shown in FIG. 24, the thickness of the test body T6 became 7.3 mm (the reduction rate is 75.7%) by the hot rolling process. By the hot rolling process, Al and Cu (that is, the box body 101 and the intermediate member 103, and the sealing body 102 and the intermediate member 103) of the test body T6 were well joined together. On the other hand, both plates of the intermediate member 103, 103 were not joined together because the removing member 106 is interposed between them.

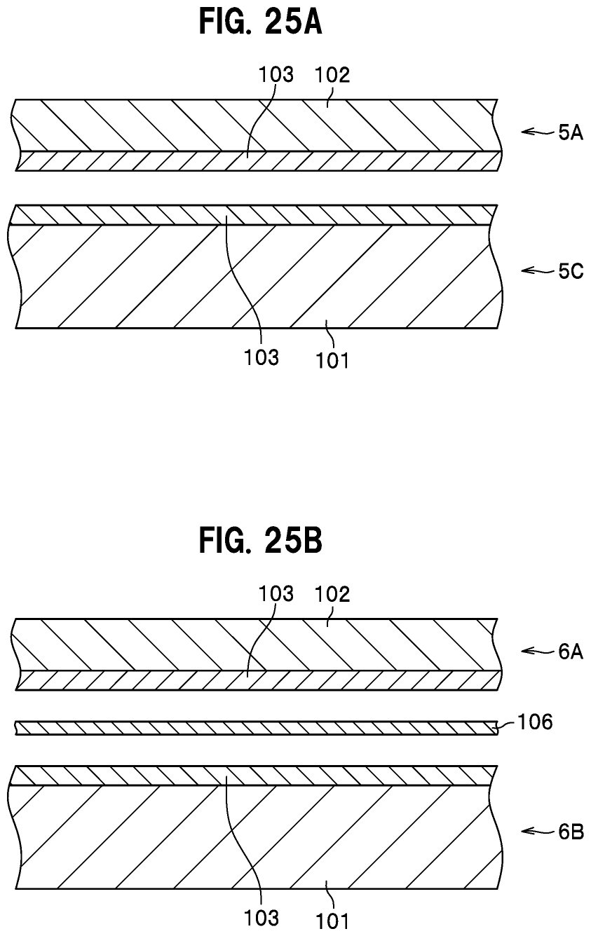

As shown in FIG. 25A, plural layer clad materials 5A, 5C composed of two layers of Al and Cu are manufactured by dividing the test body T5 after the hot rolling process at the remover 105 (refer to FIG. 22).

As shown in FIG. 25B, plural layer clad materials 6A, 6B composed of two layers of Al and Cu are manufactured by dividing the test body T6 after the hot rolling process at the removing member 106.

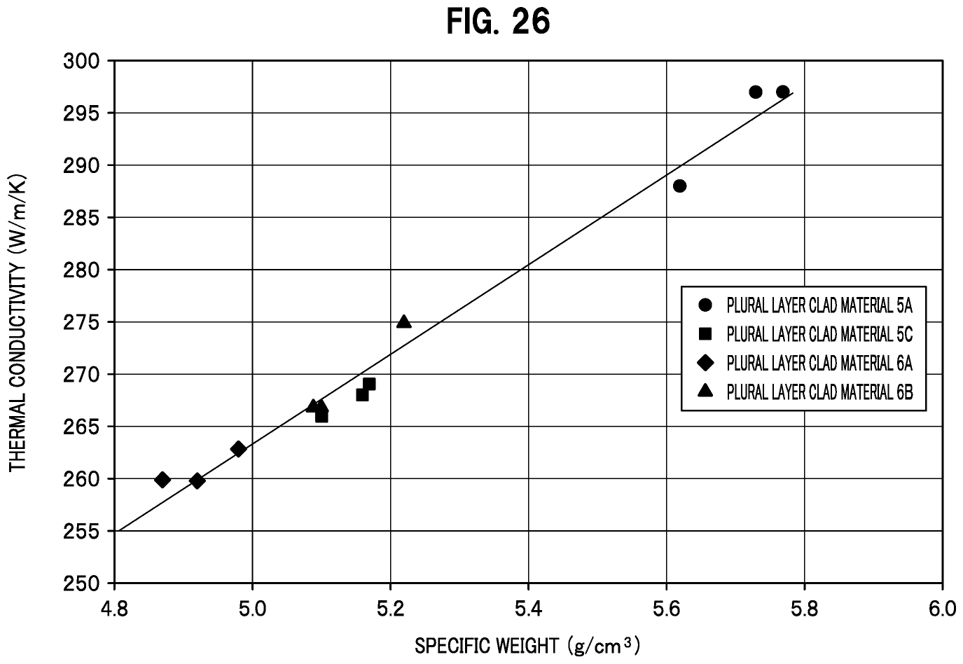

As shown in FIG. 26, common correlation was obtained from results of measuring thermal conductivities in their thickness directions relative to respective specific weights on the manufactured plural layer clad materials 5A, 5C, and the manufactured plural layer clad materials 6A, 6B. That is, like the method for manufacturing a composite slab in the example, the remover 105 or the removing member 106 is interposed, rolling is performed, and then they are divided at the remover 105 or the removing member 106. In this case, plural layer clad materials, in which the thermal conductivity in each thickness direction is proportional to the corresponding specific weight, can be manufactured.

The temperature during a hot rolling process may be adequately set according to the metal material. For example, it may be set to 460 to 600° C., preferably set to 470 to 550° C. Thus, Al and Cu can be well joined, and since both Cu and Cu cannot be joined, the dividing (removing) can be easily done. Two plural layer clad materials can be manufactured from one composite slab by dividing, so that productivity can be enhanced.

Note that, although a specific illustration is omitted, in a case where a plate member of an aluminum alloy whose front face or back face is anodized is adopted instead of the removing member 106, the dividing can be easily done like the removing member 106. Thus, two plates of plural layer clad materials composed of Al and Cu were manufactured.

### REFERENCE SIGNS LIST

1 Composite slab
2 Box body
3 Intermediate member
4 Intermediate member
5 Sealing body
14 Exhaust channel
15 Evacuation jig
F Second rotary tool (rotary tool)
F1 Connecting portion
F2 Stirring pin
G First rotary tool (rotary tool)
G1 Shoulder portion
G2 Stirring pin
J1 Butted portion

1. A method for manufacturing a composite slab to manufacture a plural layer clad material composed of different kinds of metals, the method comprising:
a preparation process to prepare a metallic box body having a bottom portion and a peripheral wall portion standing on a peripheral edge of the bottom portion, and a metallic sealing body to seal an opening of the box body;
a butting process to butt a side face of the sealing body against an inner wall face of the peripheral wall portion to form a butted portion with one or plural intermediate members being inserted in a recessed portion of the box body; and
a closing process to join and close the butted portion,
wherein at least one of the one or plural intermediate members is made of a material different from at least one of the box body and the sealing body.

2. A method for manufacturing a composite slab to manufacture a plural layer clad material composed of different kinds of metals, the method comprising:
a preparation process to prepare a metallic box body having a bottom portion and a peripheral wall portion standing on a peripheral edge of the bottom portion, and a metallic sealing body to seal an opening of the box body, and to form a peripheral wall step portion having a step bottom face and a step side face standing on the step bottom face at an inner peripheral edge of the peripheral wall portion;
a butting process to place the sealing body on the peripheral wall step portion to butt a side face of the sealing body against the step side face to form a butted portion with one or plural intermediate members being inserted in a recessed portion of the box body; and
a closing process to join and close the butted portion,
wherein at least one of the one or plural intermediate members is made of a material different from at least one of the box body and the sealing body.

3. A method for manufacturing a composite slab to manufacture a plural layer clad material composed of different kinds of metals, the method comprising:
a preparation process to prepare a metallic box body having a bottom portion and a peripheral wall portion standing on a peripheral edge of the bottom portion, and a metallic sealing body to seal an opening of the box body;
a butting process to butt a back face of the sealing body against a peripheral wall end face of the peripheral wall portion to form a butted portion with one or plural intermediate members being inserted in a recessed portion of the box body; and
a closing process to join and close the butted portion,
wherein at least one of the one or plural intermediate members is made of a material different from at least one of the box body and the sealing body.

4. The method for manufacturing a composite slab according to claim 1, further comprising:
an evacuation process to evacuate through an exhaust channel provided at the box body or the sealing body to communicate the recessed portion with the outside; and
a blocking process to block the communication through the exhaust channel after performing the closing process and the evacuation process.

5. The method for manufacturing a composite slab according to claim 4,
wherein in the preparation process, the exhaust channel is provided at the peripheral wall portion of the box body,
wherein in the closing process, the butted portion is closed by friction stirring with use of a rotary tool, and
wherein in the blocking process, the exhaust channel is crossed to be blocked by friction stir welding with use of the rotary tool.

6. A method for manufacturing a composite slab to manufacture a plural layer clad material composed of different kinds of metals, the method comprising:
a preparation process to prepare a metallic frame member, a metallic bottom member to cover one opening of the frame member, and a metallic sealing body to cover the other opening of the frame member;
a butting process to butt the frame member, the bottom member, and the sealing body against each other to form butted portions with one or plural intermediate members being inserted in an inside of the frame member; and
a closing process to join to close the each butted portion,
wherein at least one of the one or plural intermediate members is made of a material different from at least one of the bottom member and the sealing body.

7. The method for manufacturing a composite slab according to claim 6, further comprising:
an evacuation process to evacuate through an exhaust channel provided at the frame member, the bottom member or the sealing body to communicate the inside with the outside; and
a blocking process to block the communication through the exhaust channel after performing the closing process and the evacuation process.

8. The method for manufacturing a composite slab according to claim 7,
wherein in the preparation process, the exhaust channel is provided at the frame member,
wherein in the closing process, the each butted portion is closed by friction stir welding with use of a rotary tool, and
wherein in the blocking process, the exhaust channel is crossed to be blocked by friction stirring with use of the rotary tool.

9. A method for manufacturing a composite slab to manufacture a plural layer clad material composed of different kinds of metals, the method comprising:
a butting process to enclose around one intermediate member with plural closing members and butt each member against each other to form a butted portion;
an evacuation process to evacuate through an exhaust channel to communicate an inside of the closing members with the outside;
a closing process to join and close the butted portion; and
a blocking process to block the communication through the exhaust channel after performing the closing process and the evacuation process,
wherein the intermediate member is made of copper or a copper alloy, and the closing members are made of aluminum or an aluminum alloy.

10. A method for manufacturing a composite slab to manufacture a plural layer clad material composed of different kinds of metals, the method comprising:
a butting process to enclose around two intermediate members with plural closing members and butt the closing members against each other to form butted portions;
an evacuation process to evacuate through an exhaust channel to communicate an inside of the closing members with the outside;
a closing process to join and close the butted portion; and
a blocking process to block the communication through the exhaust channel after performing the closing process and the evacuation process,
wherein the two intermediate members are made of copper or a copper alloy, and the closing members are made of aluminum or an aluminum alloy.

11. The method for manufacturing a composite slab according to claim 10,
wherein in the butting process, remover or a removing member is interposed between the two intermediate members to peel off the two intermediate members from each other.

12. The method for manufacturing a composite slab according to claim 11,
wherein the removing member is made of an aluminum alloy containing 2 mass % or more of Mg.

13. The method for manufacturing a composite slab according to claim 11,
wherein the removing member is made of aluminum or an aluminum alloy, and at least one of a front face and a back face of the removing member is anodized.

14. A method for manufacturing a composite slab to manufacture a plural layer clad material composed of different kinds of metals, the method comprising:
a butting process to enclose around three or more intermediate members with plural closing members and butt the closing members against each other to form butted portions;
an evacuation process to evacuate through an exhaust channel to communicate an inside of the closing members with the outside;
a closing process to join and close the butted portion; and
a blocking process to block the communication through the exhaust channel after performing the closing process and the evacuation process,
wherein two or more of the intermediate members are made of copper or a copper alloy, and one or more of the intermediate members are made of aluminum or an aluminum alloy, and
wherein the closing members are made of aluminum or an aluminum alloy.

15. The method for manufacturing a composite slab according to claim 14,
wherein in the butting process, remover or a removing member is interposed between two of the intermediate members to peel off the two from each other, the two being made of copper or a copper alloy.

16. The method for manufacturing a composite slab according to claim 15,
wherein the removing member is made of an aluminum alloy containing 2 mass % or more of Mg.

17. The method for manufacturing a composite slab according to claim 15,
wherein the removing member is made of aluminum or an aluminum alloy, and at least one of a front face and a back face of the removing member is anodized.

18. The method for manufacturing a composite slab according to claim 2, further comprising:
an evacuation process to evacuate through an exhaust channel provided at the box body or the sealing body to communicate the recessed portion with the outside; and
a blocking process to block the communication through the exhaust channel after performing the closing process and the evacuation process.

19. The method for manufacturing a composite slab according to claim 18,
wherein in the preparation process, the exhaust channel is provided at the peripheral wall portion of the box body,
wherein in the closing process, the butted portion is closed by friction stirring with use of a rotary tool, and
wherein in the blocking process, the exhaust channel is crossed to be blocked by friction stir welding with use of the rotary tool.

20. The method for manufacturing a composite slab according to claim 3, further comprising:
an evacuation process to evacuate through an exhaust channel provided at the box body or the sealing body to communicate the recessed portion with the outside; and
a blocking process to block the communication through the exhaust channel after performing the closing process and the evacuation process.

21. The method for manufacturing a composite slab according to claim 20,
wherein in the preparation process, the exhaust channel is provided at the peripheral wall portion of the box body,
wherein in the closing process, the butted portion is closed by friction stirring with use of a rotary tool, and
wherein in the blocking process, the exhaust channel is crossed to be blocked by friction stir welding with use of the rotary tool.
